(19) United States
(12) Patent Application Publication
(10) Pub. No.: US 2012/0048074 A1
(43) Pub. Date: Mar. 1, 2012

(54) Hand Tool with Ergonomic Handle, and Ergonomic Handle for Hand Tool

(75) Inventor: John Mosher, Hopkinton, MA (US)

(73) Assignee: Elements Industrial Design, Inc., Hopkinton, MA (US)

(21) Appl. No.: 13/216,302

(22) Filed: Aug. 24, 2011

Related U.S. Application Data
(60) Provisional application No. 61/376,702, filed on Aug. 25, 2010.

(51) Int. Cl. B25G 1/06; B25G 1/10

(52) U.S. Cl. 81/489; 16/430

(57) ABSTRACT

A hand tool with a shaft, and a working implement at one end of the shaft. The shaft is adapted to be gripped at or proximate its other end. The shaft defines a generally straight proximal portion at or proximate the proximal end of the tool and a generally straight distal portion proximate the distal end of the tool, these two portions lying generally along the longitudinal axis of the shaft. The working implement is coupled to the distal portion of the shaft. There is a handle member coupled to both the proximal portion and the distal portion of the shaft, the handle member defining a loop that is offset from the longitudinal axis of the shaft, and may have a general “C” shape.

### CROSS REFERENCE TO RELATED APPLICATION

This application claims priority of Provisional Patent Application Ser. No. 61/376,702 filed on Aug. 25, 2010, the entire contents of which are incorporated herein by reference.

### FIELD

The present invention is in the technical field of hand tools. More specifically the present invention is in the technical field of tools with long handles, such as shovels, rakes and similar hand tools.

### BACKGROUND

Conventional hand tools such as shovels, rakes and related/similar hand tools typically have long straight handles, or (in the case of snow shovels) can have a curved or bent “ergonomic” handle. Other hand tools such as vacuum cleaners have a handle with a tool or other implement at the distal end, and are held by one or both hands. The types of handles generally available are either straight or bent. It is difficult to shovel or rake efficiently with these handles. The straight shaft requires that the operator bend down to use the tool. The bent shaft handles require that the operator bend down slightly less, but the offset bend positions the operator at a mechanical disadvantage resulting in minimal relief for the lower back. It is not uncommon for the operator of such tools to experience fatigue, especially in the region of the back, lower back and shoulders.

### SUMMARY

The present invention is an ergonomic improvement to hand tools, including but not limited to such hand tools as shovels, rakes, hoes and similar. A primary handle member is attached to a conventional tool shaft. Alternatively, the handle member can be integrated into the shaft. In either case, the handle can be applied to elongated hand tools that do not have a shaft per se, but which typically include an elongated portion that has a working implement at the distal end and needs to be controlled by one or both hands of the user, one example being some styles of upright vacuum cleaners. Other examples include but are not limited to weed whackers, floor sanders, edgers, snow pushers, grain shovels, squeegees, trash sweepers/dustpans, brooms, leaf rakes, landscape rakes, hoes, pitchforks, metal detectors and steam cleaners.

The handle member may define one or more gripping portions that are offset from the longitudinal axis of the tool shaft. The handle member may be roughly loop shaped to allow for a variety of hand positions relative to the implement as well as an improvement to the posture of the user. The multiple hand positions and improved posture result in the user being able to perform a task with less effort and strain. The ability to utilize multiple positions allows the user to disperse the workload over various areas of the body and avoid overworking one specific area of the user's physique. The advantage of the handle member over prior handles is the improved ergonomics while improving the versatility of the implement for the user rather than limiting it based on an ergonomic improvement of a more limited scope.

Featured in one embodiment is an ergonomic handle for a hand tool with an elongated shaft that lies along a shaft axis and carries a working implement at one end and defines a grasping area at the other end. The handle comprises an elongated handle member, and a first connector that connects the handle member to the shaft proximate the grasping area of the shaft. The handle member defines a first portion coupled to the connector and projecting away from the shaft axis at a first angle and that leads to a second portion that lies at a second angle that is shallower than the first angle, to define an auxiliary grasping area displaced from the shaft.

The handle member may further define a third portion coupled to the second portion, wherein the third portion is generally parallel to the shaft axis. The handle may further comprise a second connector that connects the handle member to the shaft proximate the working implement, wherein the handle member defines a loop shape. The handle member may further define a fourth portion that leads from the third portion to the second connector. The fourth portion may comprise two generally straight sections with a bend between them.

Featured in another embodiment is a hand tool comprising a shaft with a working implement at its distal end, wherein the shaft is adapted to be gripped at or proximate its proximal end. The shaft defines a generally straight proximal portion at or proximate the proximal end of the tool and a generally straight distal portion proximate the distal end of the tool, wherein these two portions are aligned at least generally along a longitudinal axis of the shaft. The working implement is coupled to the distal portion of the shaft. There is a handle member coupled to both the proximal portion and the distal portion of the shaft, the handle member defining a loop that is offset from the longitudinal axis, and typically but not necessarily defining a general “C” shape.

The hand tool may further comprise a handle coupled to the proximal end of the shaft. The shaft may run from the handle to the working implement. The handle member may define a gripping portion offset from and generally parallel to the longitudinal axis of the shaft. The handle member may further define first and second angled portions leading from the gripping portion toward the shaft. The shaft may be telescoping. The handle member may define one or more pivots. The handle member may be telescoping. The handle member may define a plurality of pivots. The hand tool may further comprise a support coupled to the handle member. The support may be generally parallel to the longitudinal axis of the shaft. The hand tool may further comprise a grip coupled to the handle member. The grip may be movable along the handle member and/or may be rotatable relative to the handle member.

### BRIEF DESCRIPTION OF THE DRAWINGS

FIG. 1 is a perspective of a hand tool (shovel) that incorporates an embodiment of the handle member.

FIGS. 2A and 2B are side and top views of the shovel of FIG. 1.

FIGS. 3A-3C are enlarged views of an example of an attachment of the handle member to the tool shaft.

FIG. 4 is an enlarged view of an alternative attachment of the handle member to the tool shaft.

FIGS. 5A-5C show three options for adjustment of the tool shaft in a telescopic fashion at one or more points.

FIG. 6 is a detail view of a clamping mechanism of FIGS. 5A-5C.

FIG. 7 shows a telescopic adjustment on the handle member.

FIG. 8 is a detail view of a pivot/hinge point for embodiments of the invention.

FIG. 9 is a variation of a handle member with both a pivot point and a flexible component.

FIGS. 10A and 10B are assembled and collapsed views of a collapsible handle member embodiment with multiple pivot/hinge points.

FIG. 11 is a detail view of a pivot that may be fixed in multiple angular positions.

FIGS. 12A-12C show multiple variations of a handle member mounted on a hoe.

FIGS. 13A and 13B illustrate the angles and dimensions that may be used to achieve the desired function, as well as the preferred embodiment for a snow shovel.

FIG. 14 illustrates a person scraping with a shovel

FIG. 15 illustrates a person lifting with a shovel

FIG. 16 illustrates a person undertaking a full lift with a shovel with a light load.

FIG. 17 illustrates a person undertaking a full lift with a shovel with a heavy load.

FIG. 18 illustrates a person reaching with a shovel to chop a snow bank.

FIG. 19 illustrates a person using the conventional shovel handle to clear a snow bank.

FIG. 20 illustrates another embodiment with an integrated shaft and handle member.

FIG. 21 illustrates another embodiment with a support for the handle member.

FIGS. 22A and 22B illustrate other embodiments with a grip coupled to the handle member.

### DETAILED DESCRIPTION OF EMBODIMENTS

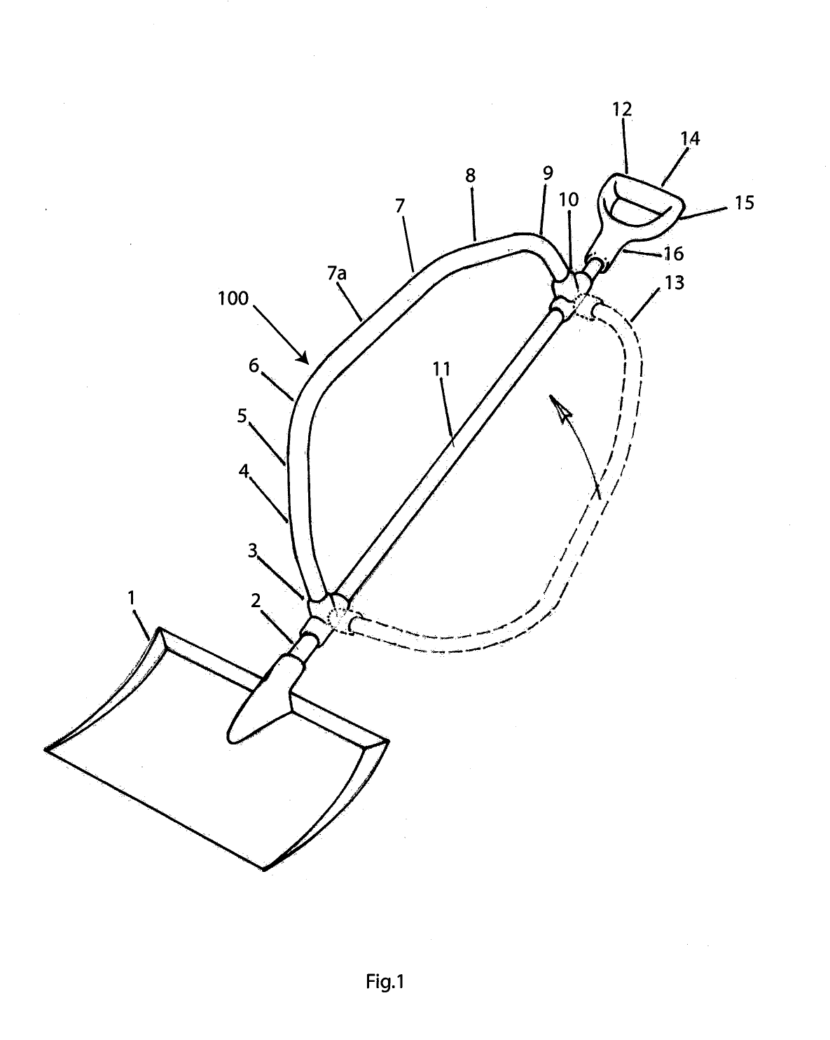

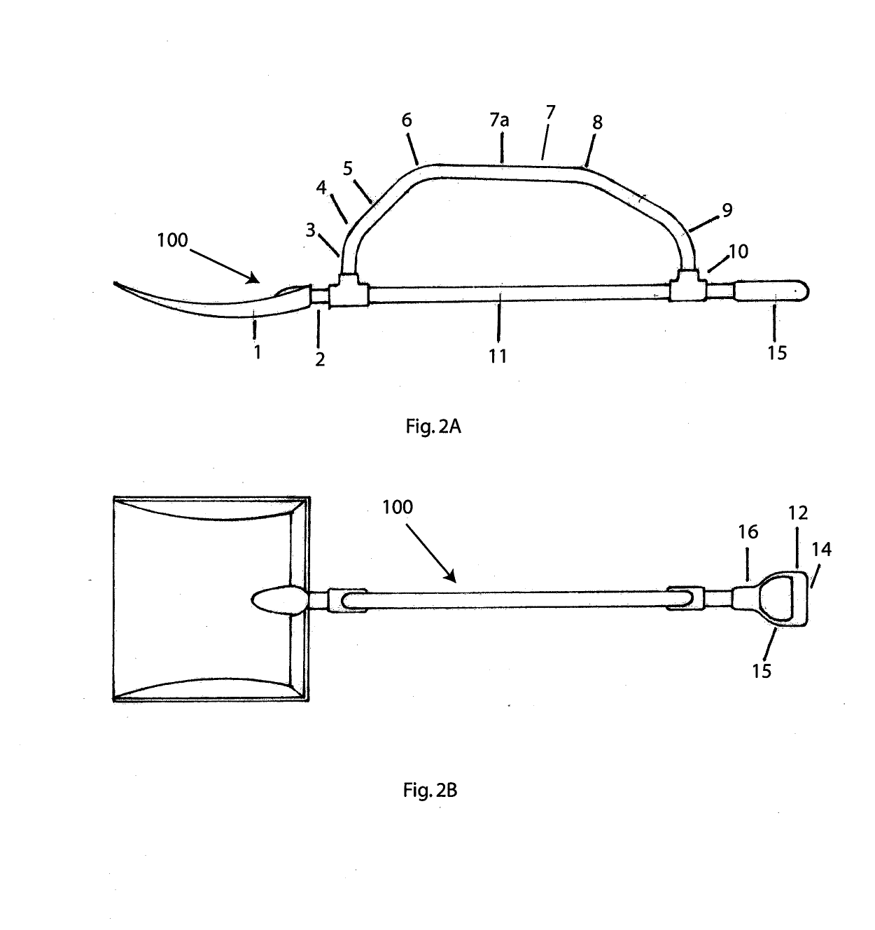

FIGS. 1 and 2 show a shovel 100 having a straight shaft 11 upon which is attached at the distal end the blade portion 1, and at the other (proximal) end there is an optional small handle 12. Between the handle and the blade (or other working implement of the tool) is a primary handle member 7 that generally defines a loop, with a general “C” shape.

In further detail still referring to FIGS. 1 and 2, the loop 7 is sufficiently long enough to allow for multiple hand positions and rises above the shaft 11 to allow the user to stand significantly more upright while performing the task. The length may be 28″ from 3 to 10 and the maximum height may be 12½″ from the shaft 11. There may be angles and curves 4, 5, 6, 7a, 8, 9 to maximize the ergonomic benefit of the invention. The shaft 11 and loop handle 7 may have a round, elliptical or other shape that is suitable for gripping.

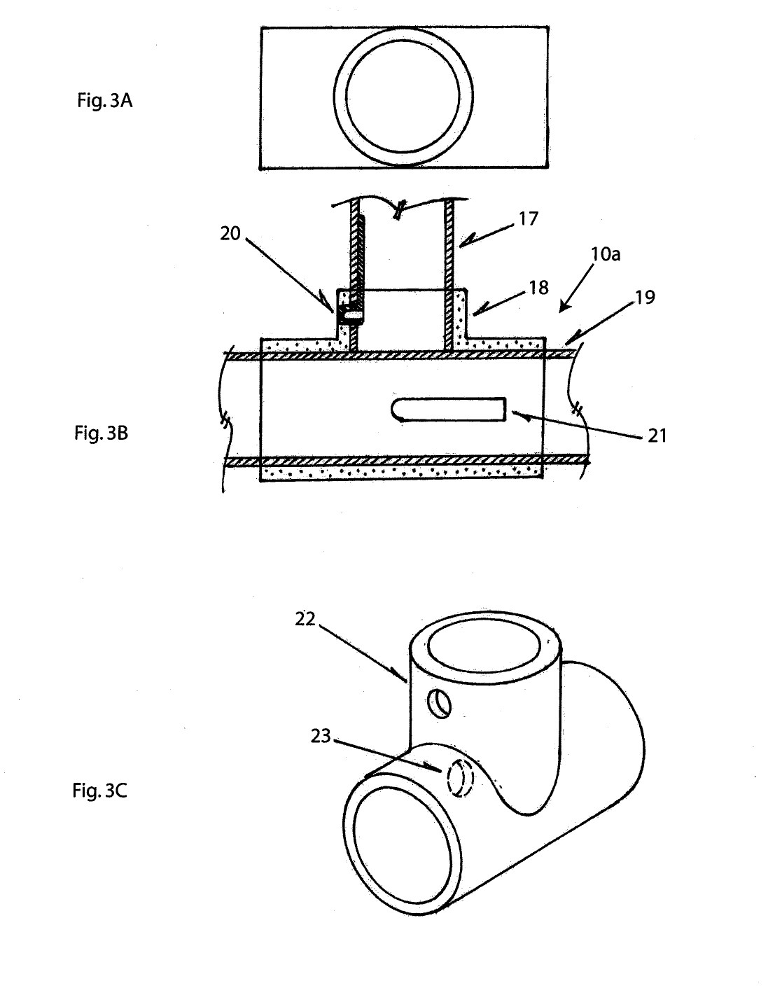

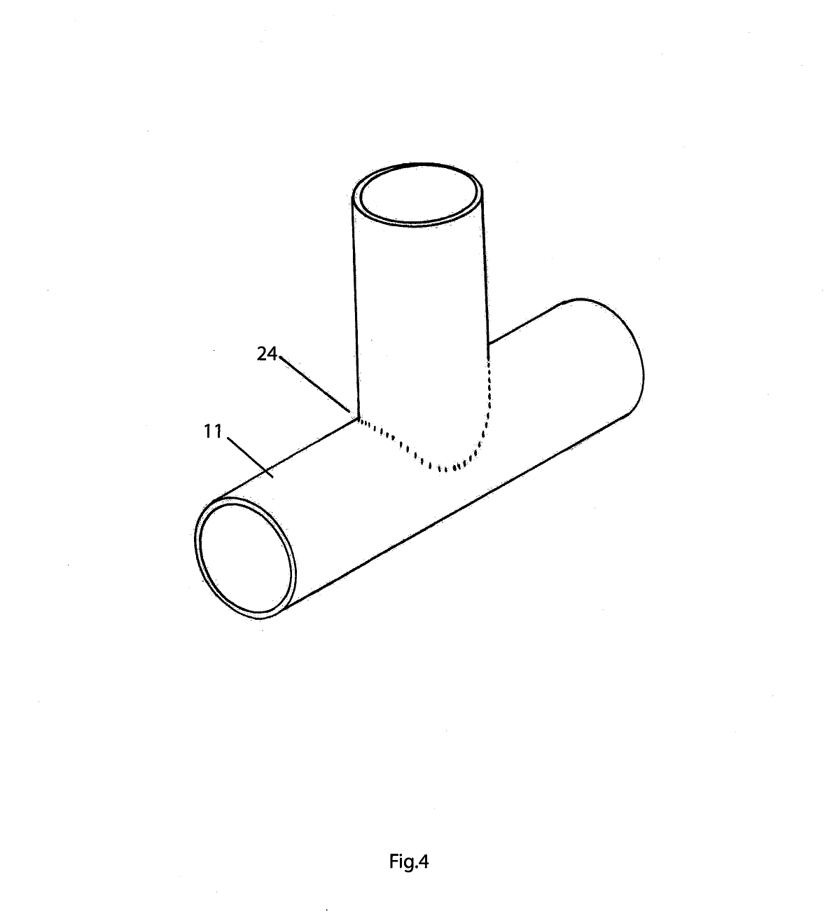

Loop handle 7 may have points of attachment 3, 10 to the shaft 11. FIG. 3 shows one assembly for such attachment 10a, in detail. The loop shaft 17 fits into the attachment fitting 18. The locking button 20 fits into the button hole 22 thus locking the loop shaft 17 into the attachment fitting 18. The straight tool handle 19 goes straight through the attachment fitting 18 and locks into place with a locking button 21 that fits into the button hole 23. Another option is shown in FIG. 4. The loop handle 7 is simply braised or welded 24 to the shaft 11.

Loop 7 may be made of any material that provides sufficient strength, shape and durability, such as plastic, metal, composite, wood, etc. The attachment points 3, 10 may be as simple as fixing the loop 7 to the shaft 11 by means such as a screw, rivet, adhesive or welding/brazing. It may also be attached to the shaft using a fitting that may be fixed or allow for rotation (90° for example) of the loop 7 to either side. The loop handle may also be attached using a button that may lock the handle to the shaft. The loop handle may also be attached to the shaft 11 by using a clamp. The loop handle may also be attached to fitting 10a, (fitting detail FIG. 3) using a button that may lock the handle to the shaft. This would allow for a reduced profile of the tool and may make shipping and storage more efficient.

Referring to FIG. 1, the loop handle member 7 may have points of attachment 3, 10 to the shaft 11. Handle member 7 may have a straight portion with a slight bend 9 to aid in putting pressure on the front of the shovel (when scraping ice for example) and for pushing the shovel forward (when pushing the shovel along the ground to remove snow for example). The bend 9 leads into the handle section 8. Section 8 may be straight or appropriately curved to allow the user to lift and manipulate the shovel while reducing the amount of bending required. Section 8 leads into section 7a, which may be straight or appropriately curved to allow the user to slide their hand along the section to achieve the most advantageous grip. Section 7a leads into bend 6, and then to section 5 and bend 4 which return handle 7 back to connection point 3.

The rear handle 12 may fit over the shaft 11 and have an opening 16 large enough to accommodate the shaft 11. The handle 12 may be attached to the shaft by a variety of means, including but not limited to rivets, screws, adhesives, snap fit, cam lock, secondary clamps (or similar) or any other practical means. The handle 12 may be made of any appropriate material including plastic, composite carbon fiber, graphite, fiberglass, wood or metal etc. The handle 12 may have a grip area 14 and a method of attaching the grip area to the mounting area 15, 16. The gripping area 14 may be perpendicular to the loop handle 7 and parallel to the tool implement 1 (in this case a shovel blade).

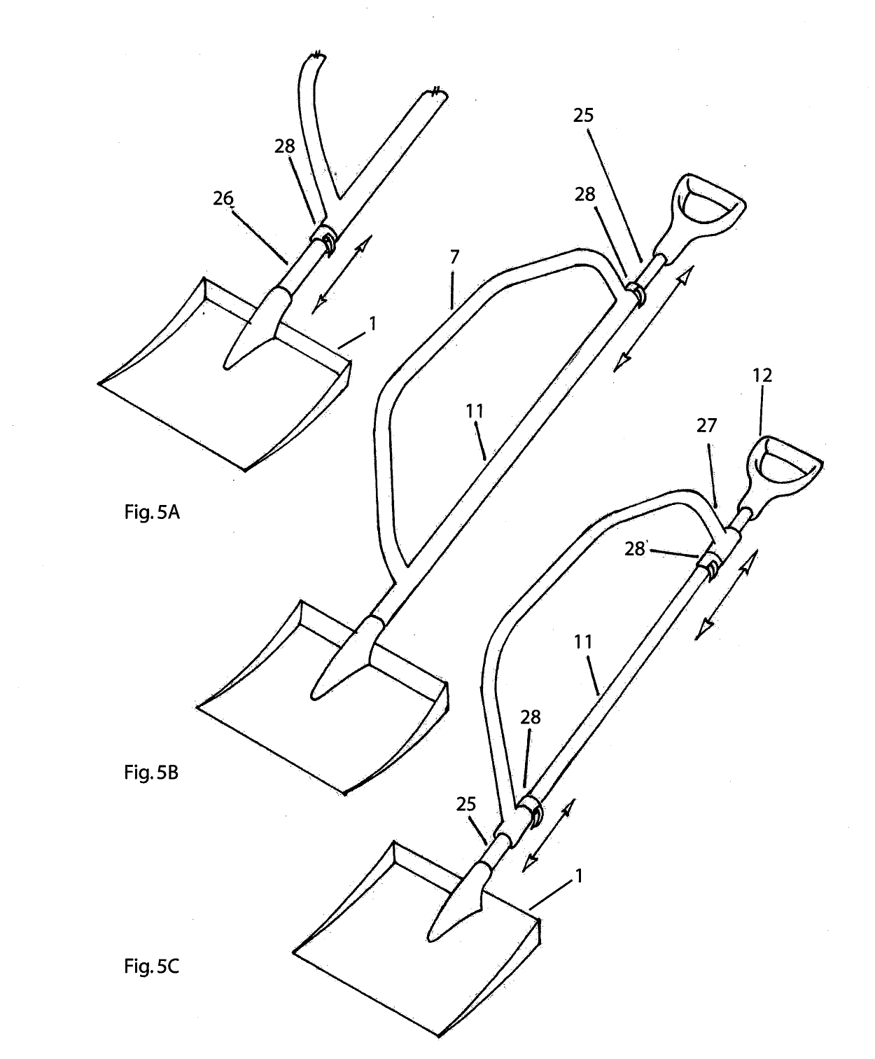

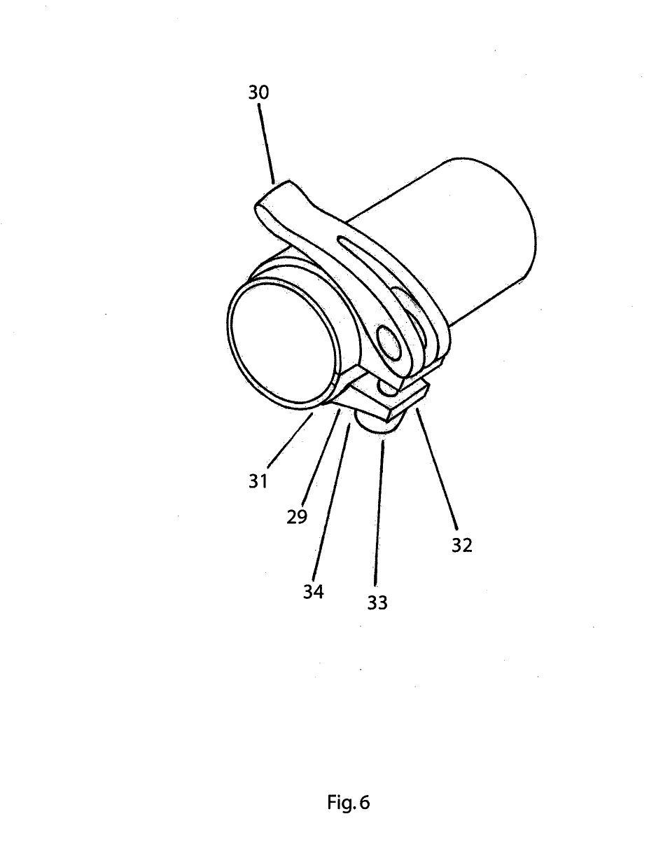

Other embodiments are shown in FIGS. 5A-5C. The loop handle 7 may be used in conjunction with a telescoping handle 25. The rear handle 12 is secured to a shaft that is a slightly smaller diameter than the main shaft 11. The shaft 25 fits into the shaft 11 and can be moved to a position that provides the most advantage to the user. The shaft 25 then may be secured inside the shaft 11 by the clamp 28. The clamp 28 (FIG. 6) may be of the type used to secure a bicycle seat post to the bicycle frame seat tube. It is a common method of clamping a tube within another tube and is widely manufactured and easily used for the intended purpose. The lever 30 may be moved to release the shaft or it may be moved to hold the shaft. As the lever 30 is moved its cam shape 32 applies pressure to lobes 34 that are on either side of a gap 31 in the outer shaft. The gap is reduced in dimension from the pressure applied by the cam 32. The pressure may be adjusted by a bolt 33 which may be loosened or tightened to adjust the pressure of the clamp 28. The implement 1 (in this case a snow shovel blade, but could be a rake, hoe, etc.) can also be mounted upon a telescopic shaft 25, and adjustable and secured in a manner similar to the description of the telescoping handle by using a shaft 25 within a larger diameter shaft 11 and secured by a clamp 28. The loop handle 7 can also be made adjustable on the shaft 11 by securing the loop handle 7 to the shaft 11 by using a larger diameter tube 27 (or rectangle, ellipse, trapezoid or any symmetrical or asymmetrical shape that allows the loop handle 7 to slide and then be fixed at the desired point upon the shaft 11) that is secured in place by using clamps 28 or lock buttons as in FIG. 3 or any other practical means that provides the desired result of securing the loop handle 7 in the desired location.

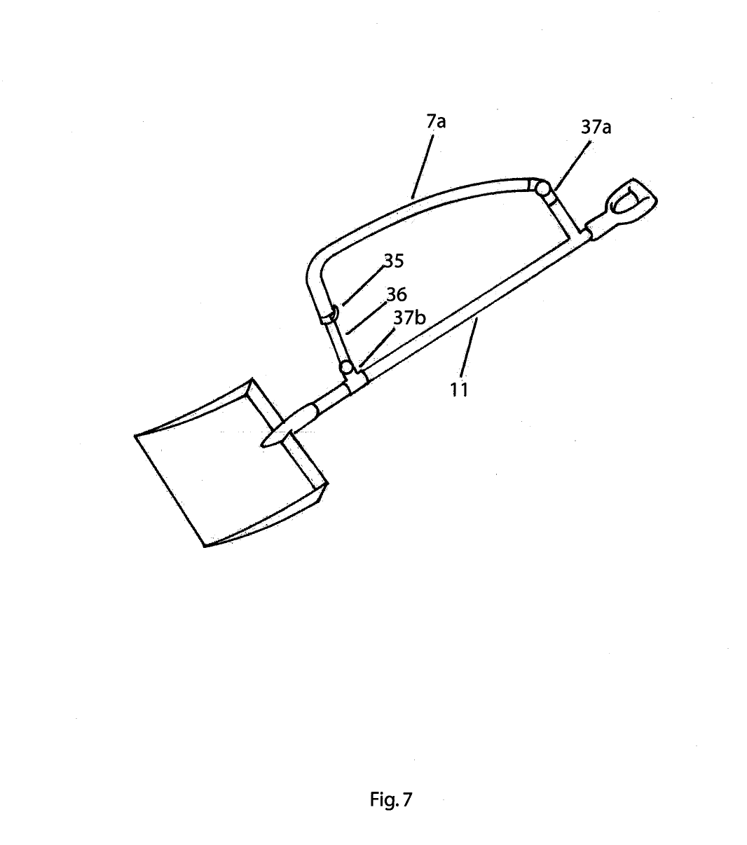

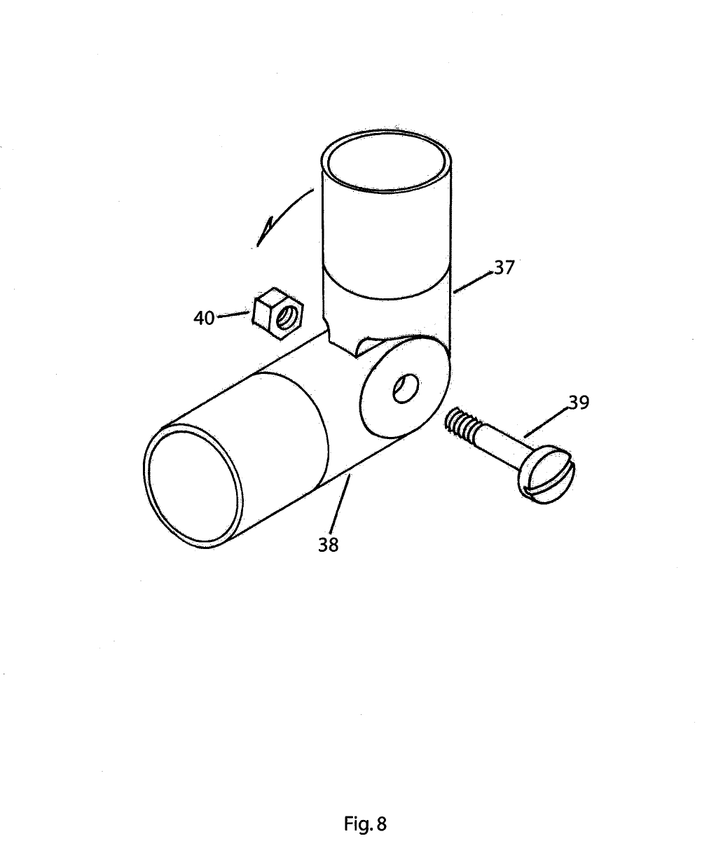

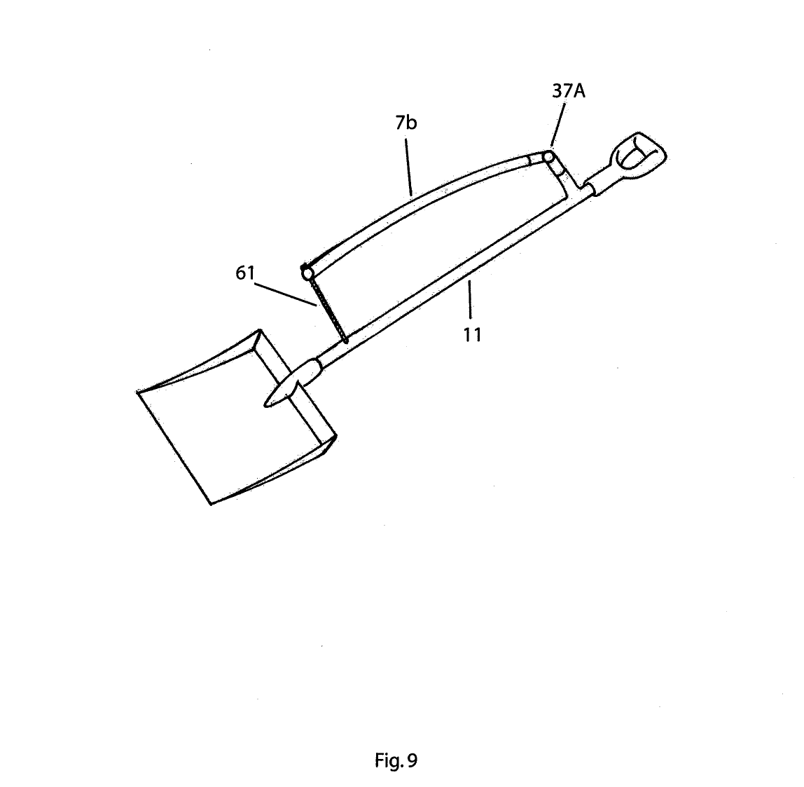

Another embodiment is shown in FIG. 7. The loop handle 7a has adjustable and fixable pivots 37A and 37B (see FIG. 8 for detail). Pivots 37A, 37B allow for a measure of height adjustment that raises and lowers the loop handle 7a in relation to the shaft 11. This would allow for the user to adjust the height of the loop handle 7a to the most advantageous position for the individual user and potentially accommodate variances in height and strength, arm or leg length, worksite conditions etc. The loop handle can be fixed into multiple positions as desired with a telescoping shaft 36. The telescoping shaft 36 may be locked into place using a clamp 35, FIG. 6, or a lock button FIG. 3 or any other practical means. In addition other methods may be used to secure the front of handle 7a to shaft 11; these may include, but are not limited to a cable, rope, cord, elastic or other flexible or rigid material (e.g., rope 61, FIG. 9) that provides the desired function. Handle 7b may be rigid enough that the forward portion of the handle does not require the aforementioned materials to maintain its position and thus can be eliminated altogether (i.e., the handle can be cantilevered). The pivot 37A may be attached to the loop handle 7a and telescopic shaft 36 or integral to the shaft itself. FIG. 8 shows the pivot 37A inserted into the shaft with a bolt 39 and nut 40 securing the pivot; this is only one example of a pivot, there are many other practical methods available.

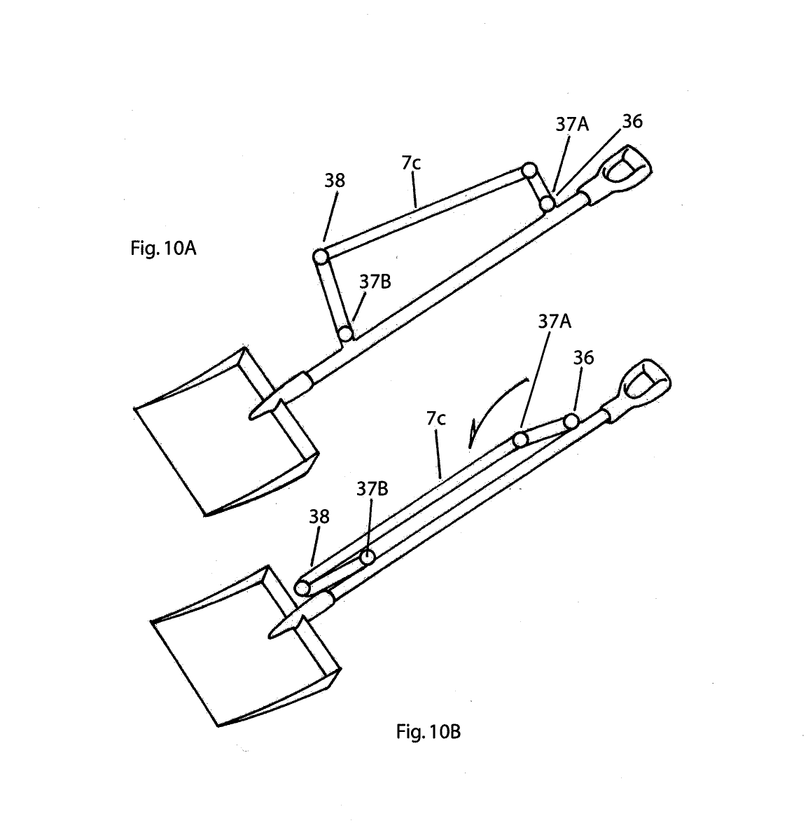

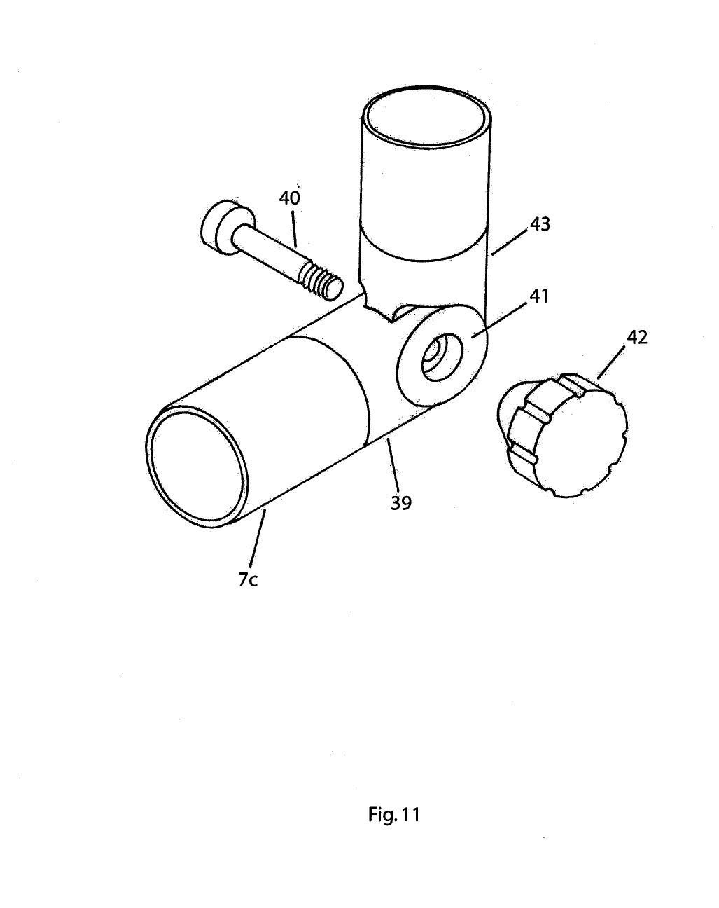

In still another configuration see FIGS. 10A and 10B. The handle 7c may incorporate multiple pivot points 36, 37A, 37B, 38. One or more of these pivots may include a locking pivot, FIG. 11, to secure the handle in the desired position. The shaft 7c may be secured to the end of the hinge 43. The angled area of handle 7c may be secured to the other end of the hinge 39. A bolt securing the two elements of the hinge together can be tightened and therefore fixed at the desired angle by tightening the knob 42. This is but one example of a way to achieve the desired function. There are other practical means as well such as ratchets, spring-loaded ball and detent, lock rings and clamps. The advantage of this configuration is the variety of positions that may be obtained. It may also reduce the dimensions and allow for more compact storage and shipping.

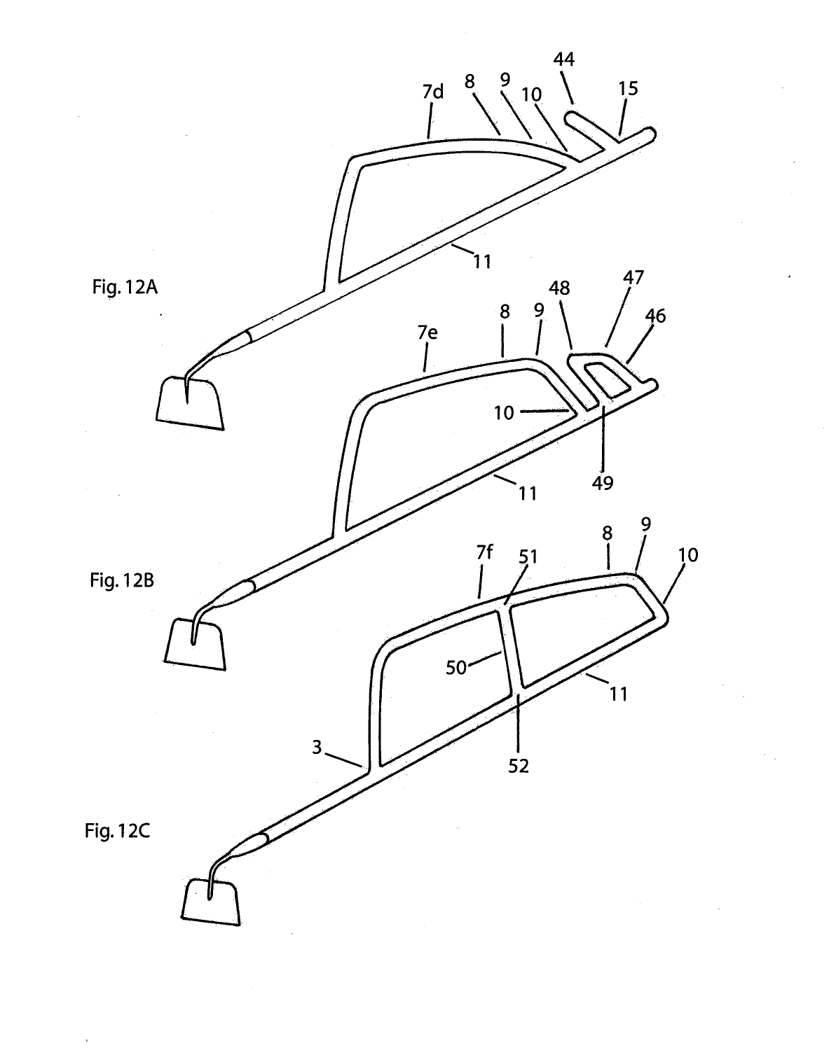

In yet another configuration the handle and areas 8, 9 and 10 may be separate and still achieve the desired function. FIG. 12A shows the handle 7d attached to the shaft 11. The area 9 and 10 is accomplished with a separate piece 44 that is attached to the shaft 11 at point 45. Another variation is shown in FIG. 12B with the handle 7e forming a separate loop with the bend 48 leading back to the shaft 11. The handle 47 is attached to the shaft 11 at points 46 and 49. Yet another variation (FIG. 12c) has the loop handle 7f attached at two points 3 and 10. Another piece 50 that is integral, removable or separately attached, is attached at location 51 to the loop handle 7f and also attached at location 52 to the shaft 11.

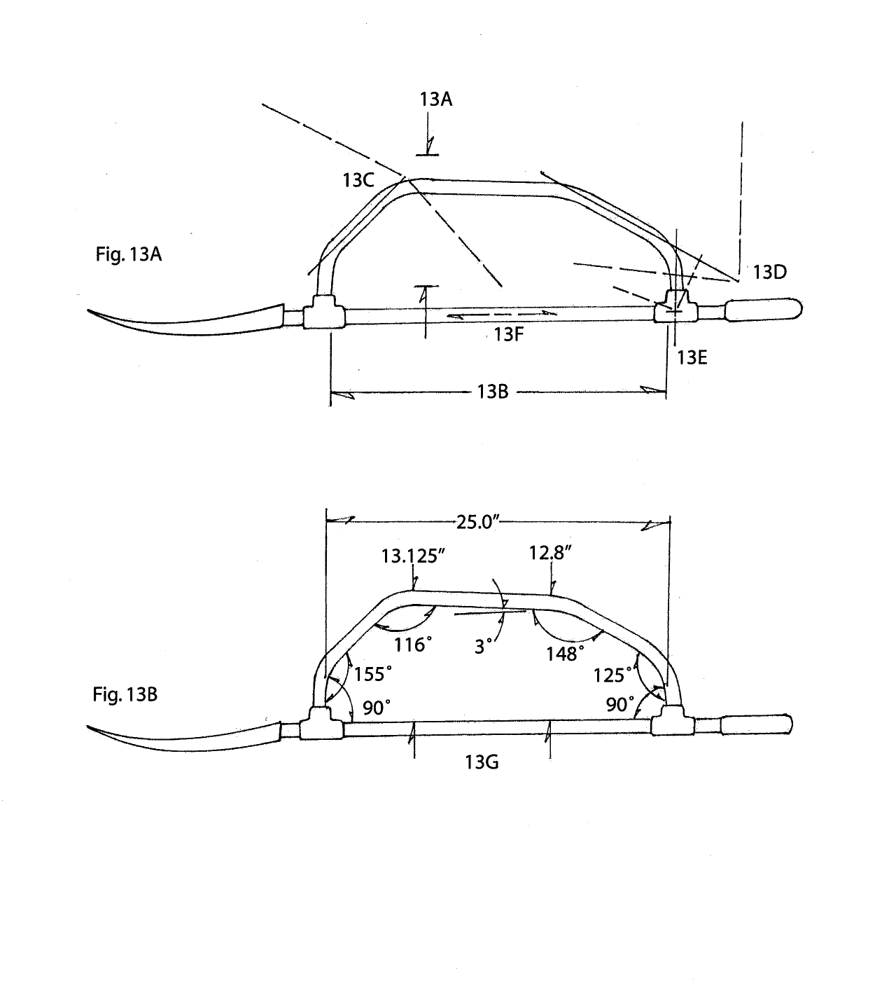

Refer now to FIGS. 13A and 13B, showing specific angles and measurements that place the user's hands in the desired locations and allows for optimum posture and implement versatility, in one exemplary non-limiting embodiment of the invention. 13A—This area of the handle raises the working height of the hands (2″-18″ above axis 13F). 13B—The total length of the loop/handle is over 25% of the working handle length from the user end of the handle to the implement attachment point. 13C—If the handle utilizes a forward mounting point it may be up to 40° undercut toward the user end of the handle and up to 120° if no forward mounting point is used. Refer to the working axis (the longitudinal axis of the shaft) as 0°. 13D—Angle of the handle immediately forward of the mount (and the area to apply downward pressure); may be from 5°-90° relative to the working axis. 13E—Area which enables downward pressure to be applied onto the front of the implement may be 25° to 120° relative to the working axis. 13F—The working axis. 13G—Preferred embodiment for snow shovels.

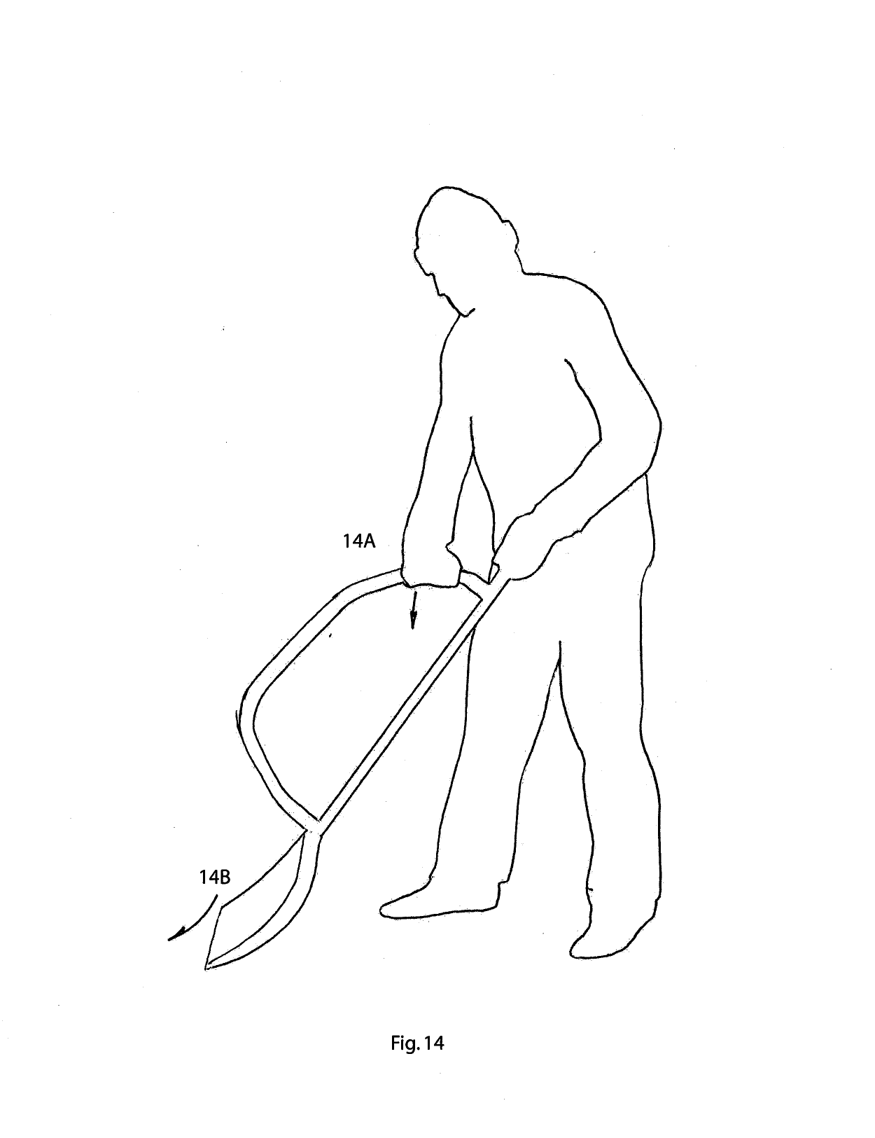

Referring now to FIG. 14, the user is able to exert significant downward pressure on location 14A resulting in edge 14B being pressed into or against the material to be removed. This is done with considerably less effort because the user is able to remain more upright. The user may reduce the need to bend by over 40° in this position.

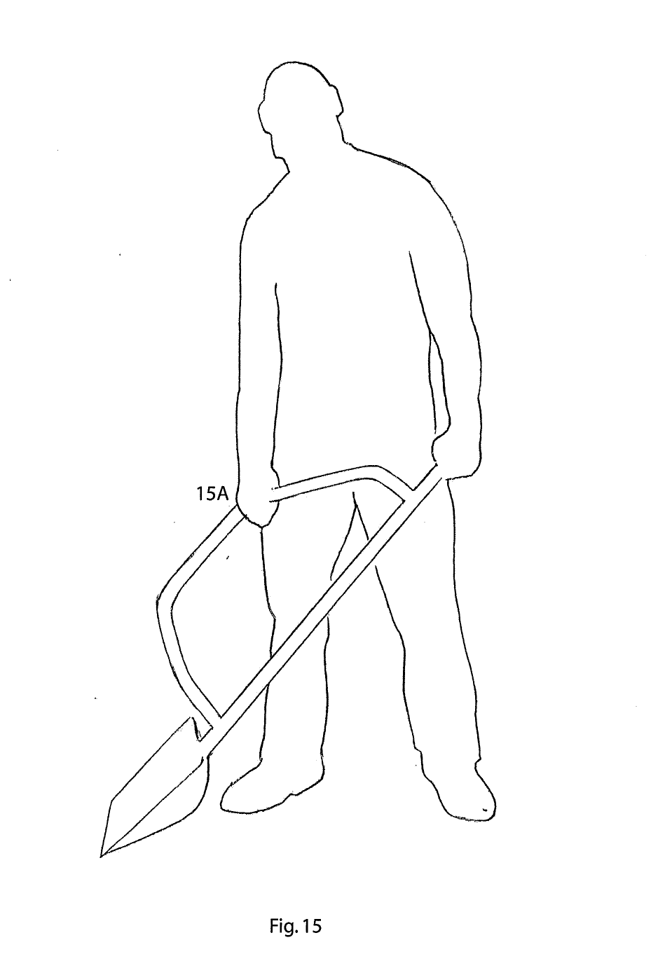

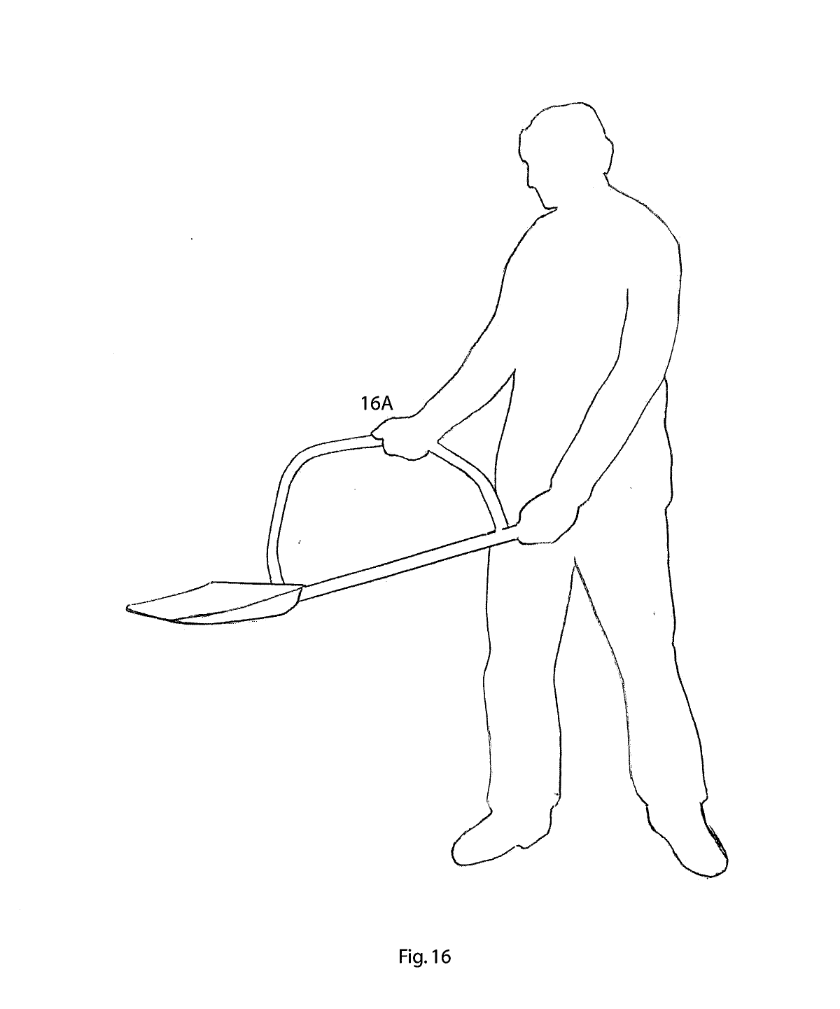

Referring now to FIG. 15, the user is able to scoop and lift with considerably less effort by holding the handle at location 15A. The user is able to remain more upright, the user may remain over 50° more upright. The user may also slide the hand over the handle to quickly realize the optimum working position. FIG. 16 demonstrates the user's ability to lift the load with minimum movement of the back thus reducing strain on that area. The hand may move as needed (e.g., to location 16A) to adapt to the requirements of the task.

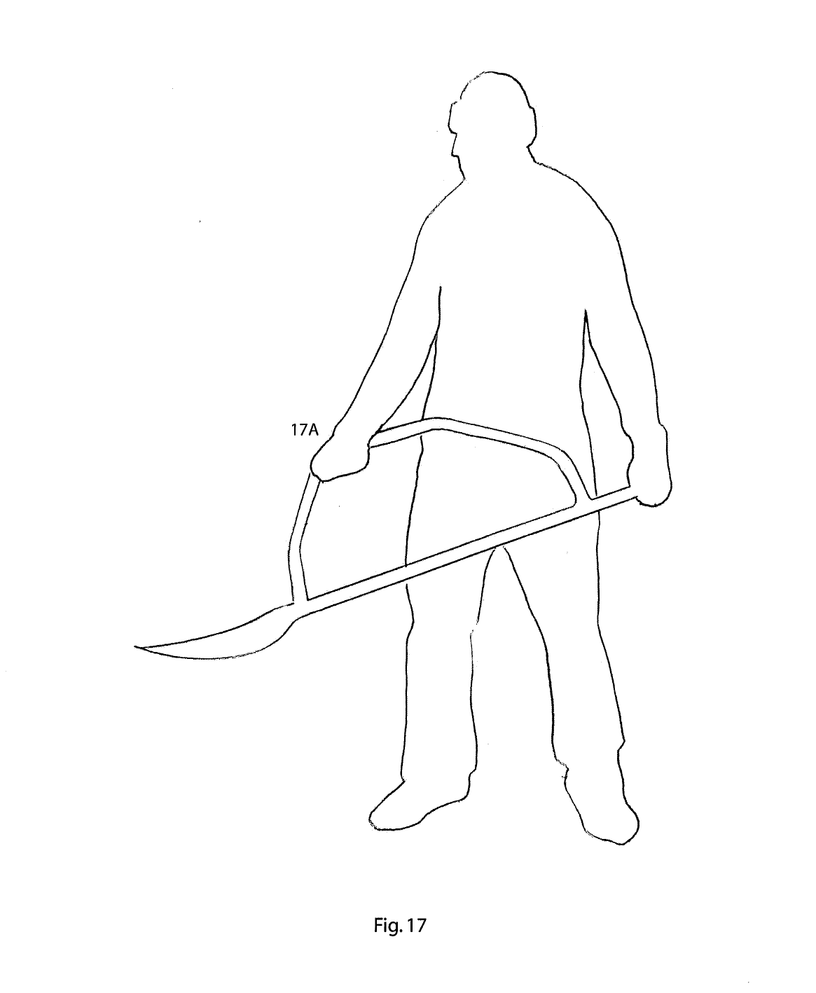

FIG. 17 demonstrates the ability for the user to dramatically improve the leverage advantage for a heavier load. By simply moving the hand forward to location 17A the user has quickly gained a mechanical improvement with which to lift. This may be a 50° or more reduction in bending relative to obtaining a similar advantage with a conventional handle.

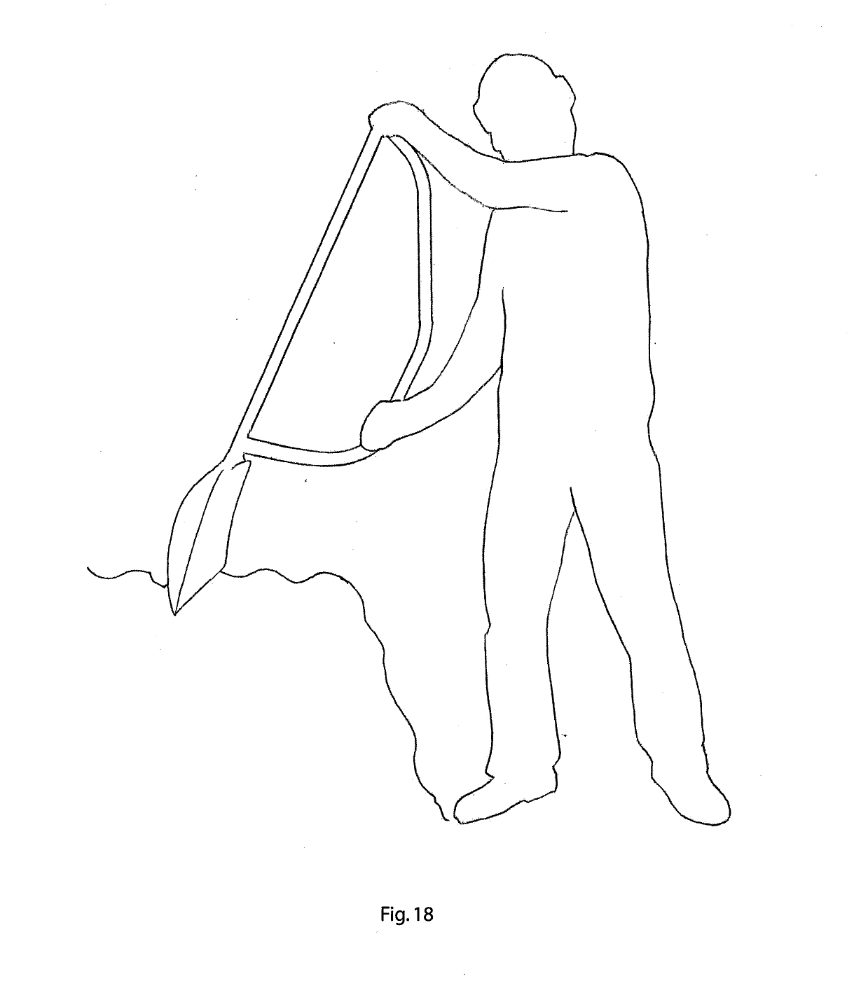

FIG. 18 demonstrates one aspect of the versatility of the invention. The user is able to rotate the shovel and thus reach into a snowbank while remaining relatively upright. A conventional handle would require the user to lean forward, the invention may require the user to lean over up to about 40° less.

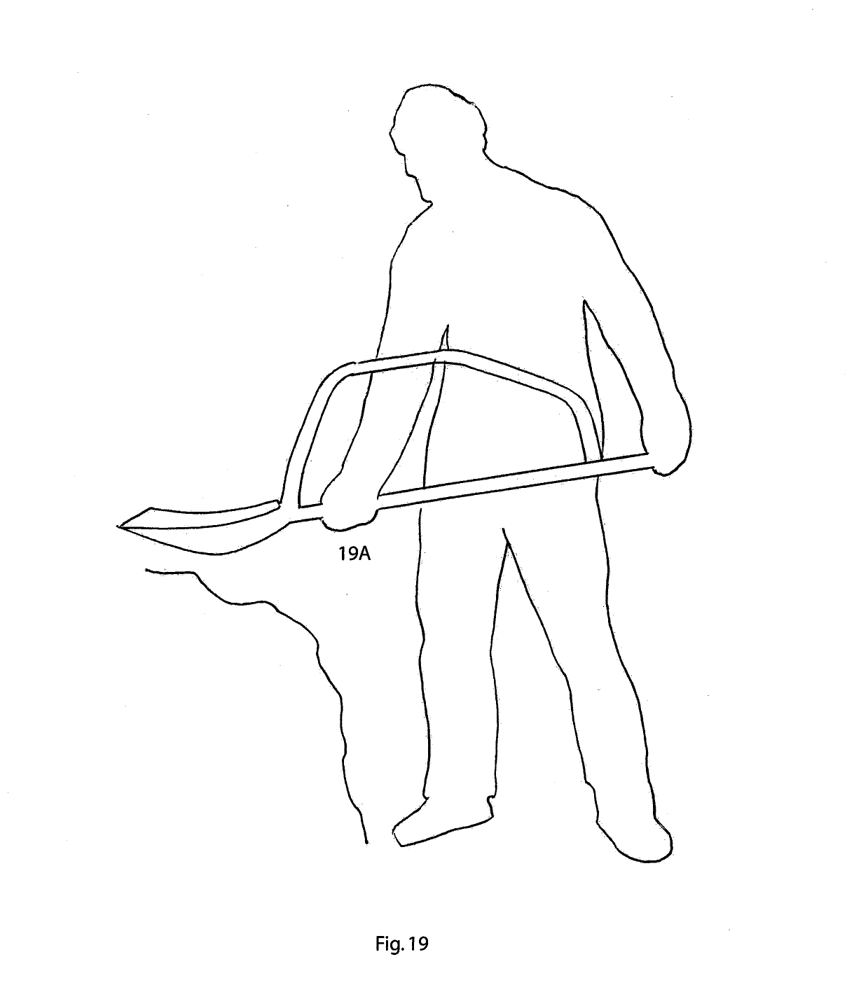

FIG. 19 again demonstrates the versatility by allowing the user to take full advantage of the standard shaft when appropriate. In this instance the snowbank is already raised and does not require the user to bend to reach it, therefore the conventional shaft is sufficient and available for the user to position their forward hand in location 19A at an advantageous position.

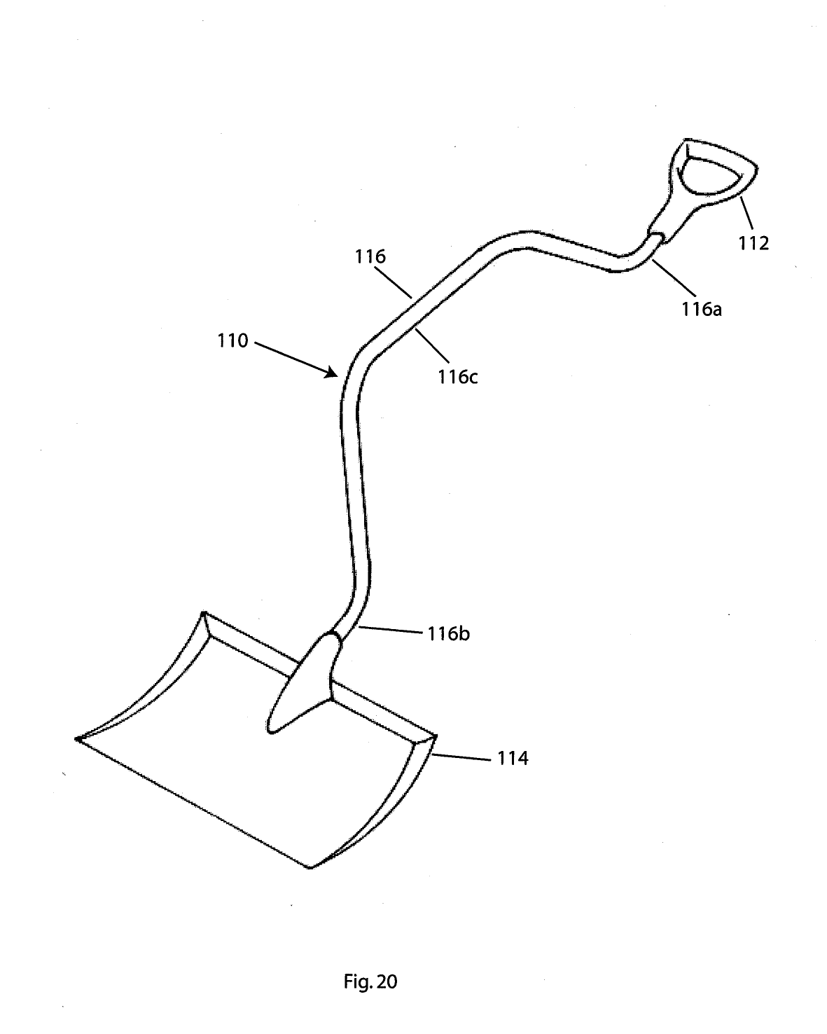

FIG. 20 illustrates shovel 110 with an integral shaft/handle member 116 that has proximal shaft portion 116a and distal shaft portion 116b that both lie generally along a single longitudinal axis, with optional handle 112 at one end and blade 114 at the other end. Handle member 116c is a generally “C” shaped part of member 116 that lies between and is coupled to portions 116a and 116c.

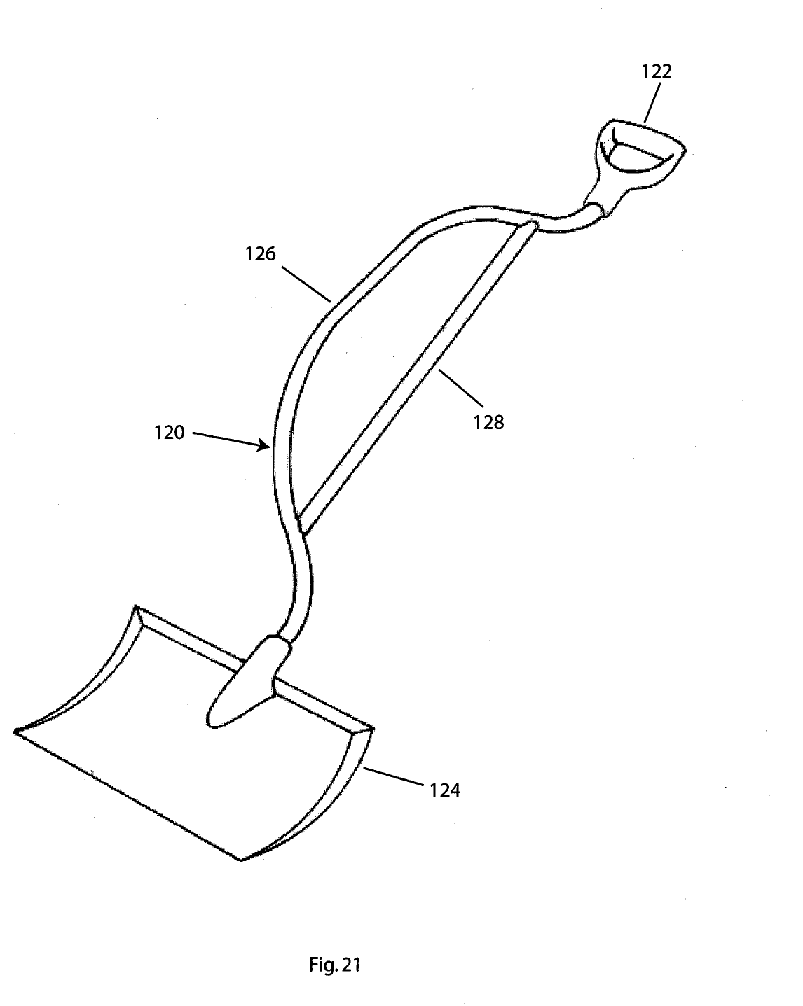

FIG. 21 shows a similar embodiment 120 in which support 128 is added, to stiffen handle member 126. Support 128 is generally parallel to the longitudinal axis of the shaft that is defined by shaft portions 116a and 116b.

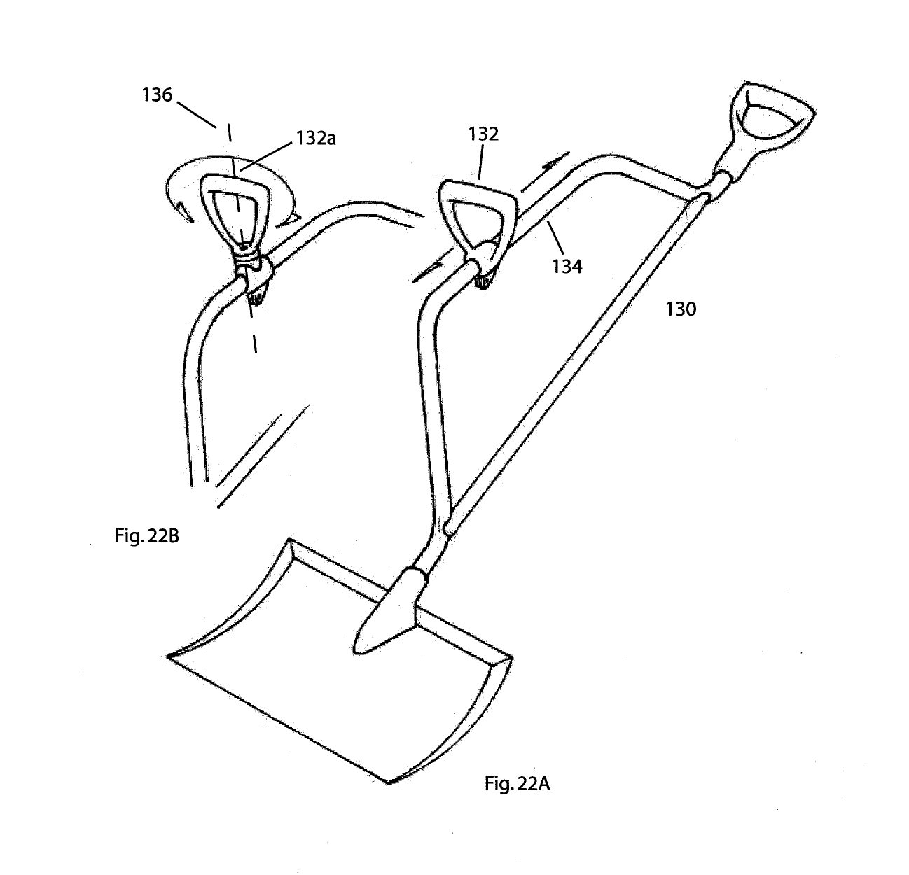

FIG. 22A shows another similar embodiment of tool 130 with additional grip 132 coupled to handle member 134. Grip 132 can be movable along the length of member 134 to allow the location of grip 132 to be varied by the user. FIG. 22B shows alternative grip 132a that is alternatively or additionally rotatable about axis 136, to allow the grip angle to be altered.

The advantages of the present invention include, without limitation that it enables the user to perform the same task as a conventional tool but with less perceived exertion. The invention can be manufactured in such a way as to make assembly, shipping and storage practical. Most shovels and other tools in this category (e.g., rake, hoe) require substantial bending over on the part of the user. Other ergonomic improvements are only effective in a specific situation. The invention allows for improved ergonomics, reduced effort and increased efficiency.

In a broad embodiment, the present invention is a handle configuration that raises the primary handle height and enables the user to perform tasks with less effort.

While the foregoing written description of the invention enables one of ordinary skill to make and use what is considered presently to be the best mode thereof, those of ordinary skill will understand and appreciate the existence of variations, combinations, and equivalents of the specific embodiments, methods and examples herein. The invention should therefore not be limited by the above described embodiments, methods and examples, but by all embodiments and methods within the scope and spirit of the invention as claimed.

1. An ergonomic handle for a hand tool with an elongated shaft that lies along a shaft axis and carries a working implement at one end and defines a grasping area at the other end, comprising:
an elongated handle member; and
a first connector that connects the handle member to the shaft proximate the grasping area of the shaft;
wherein the handle member defines a first portion coupled to the connector and projecting away from the shaft axis at a first angle and that leads to a second portion that lies at a second angle that is shallower than the first angle, to define an auxiliary grasping area displaced from the shaft.

2. The handle of claim 1 wherein the handle member further defines a third portion coupled to the second portion, wherein the third portion is generally parallel to the shaft axis.

3. The handle of claim 2 further comprising a second connector that connects the handle member to the shaft proximate the working implement, wherein the handle member defines a loop shape.

4. The handle of claim 3 wherein the handle member further defines a fourth portion that leads from the third portion to the second connector.

5. The handle of claim 4 wherein the fourth portion comprises two generally straight sections with a bend between them.

6. A hand tool, comprising:
a shaft with a working implement at its distal end, wherein the shaft is adapted to be gripped at or proximate its proximal end, the shaft defining a generally straight proximal portion at or proximate the proximal end of the tool and a generally straight distal portion proximate the distal end of the tool, wherein the proximal and distal portions are aligned generally along a longitudinal axis of the shaft, and wherein the working implement is coupled to the distal portion of the shaft; and
a handle member coupled to both the proximal portion and the distal portion of the shaft, the handle member defining a loop that is offset from the longitudinal axis.

7. The hand tool of claim 6 further comprising a handle coupled to the proximal end of the shaft.

8. The hand tool of claim 7 wherein the shaft runs from the handle to the working implement.

9. The hand tool of claim 6 wherein the handle member defines a gripping portion offset from and generally parallel to the longitudinal axis of the shaft.

10. The hand tool of claim 9 wherein the handle member further defines first and second angled portions leading from the gripping portion toward the shaft.

11. The hand tool of claim 6 wherein the shaft is telescoping.

12. The hand tool of claim 6 wherein the handle member defines one or more pivots.

13. The hand tool of claim 12 wherein the handle member is telescoping.

14. The hand tool of claim 12 wherein the handle member defines a plurality of pivots.

15. The hand tool of claim 6 further comprising a support coupled to the handle member.

16. The hand tool of claim 15 wherein the support is generally parallel to the longitudinal axis of the shaft.

17. The hand tool of claim 6 further comprising a grip coupled to the handle member.

18. The hand tool of claim 17 wherein the grip is movable along the handle member.

19. The hand tool of claim 17 wherein the grip is rotatable relative to the handle member.

20. The hand tool of claim 6 wherein the loop defines a general “C” shape.
